(19) United States
(12) Patent Application Publication
(10) Pub. No.: US 2004/0252350 A1
(43) Pub. Date: Dec. 16, 2004

(54) Data processing device with projection imaging function

(75) Inventor: Hsiang-An Hsieh, Hsindien (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/639,497

(22) Filed: Aug. 13, 2003

(30) Foreign Application Priority Data
Jun. 13, 2003 (TW) 092210884

(51) Int. Cl. H04N 1/40; G06F 15/00

(52) U.S. Cl. 358/471; 358/1.9

(57) ABSTRACT

The present invention provides a data processing device with projection imaging function, at least comprising a main body; said main body has an optical scanning mechanism that may scan any planar data page and an internal operation module for said optical scanning mechanism; said data processing device is featured with: a projection mechanism that may display data in a light projection way is disposed at an appropriate position of said main body; said projection mechanism has a projection lens, which may display image data obtained through scanning or any other form of data converted on the basis of said image data on any spatial plane.

### FIELD OF THE INVENTION

The present invention relates to a data processing device with projection imaging function, in particular to a portable data processing device that may scan data and then display the scanned data in a projection way.

### RELATED ART OF THE INVENTION

In the times when information explodes, we often have to read large quantities of newspapers, magazines, and books to study plans, sessions, briefs, etc. When we find something worthy of preservation during reading, we usually have to transcribe them in notebooks by hand, or archive them through photocopy. When we need to combine those materials collected by hand or through photocopy into an integral article, we have to enter them in PCs by hand, which is a time and manpower consuming work.

To solve above problem, a device that may directly convert written materials into digital data used in PCs through optical scanning has been invented, such as “scanner” or “scanning pen”; wherein a scanner has a mechanic platform, which comprises a transparent scanning platform and a cover; the scanning platform has an internal optical scanning unit, which is used to scan the document placed on the scanning platform. Such a scanner is very big and difficult to carry, and can't be used independently; instead, it has to be used together with storage hardware and scanning software in a PC to fulfill scanning work. Furthermore, it can only scan the entire page rather than partial image in the page, thus the scanning work is time consuming. The data acquired through scanning exists as images and can't be modified directly on the PC. To modify the data in those images, a text recognition program (e.g., OCR) or other recognition application has to be installed on the PC to convert the images into editable texts, which brings inconvenience to the user.

A scanning pen delivers the same function as the scanner. Typically, a scanning pen has a pen body with a scanning head at the front end. The scanning head contacts with the written materials directly to scan the images and store them to the internal memory of the scanning pen. The pen body has a display screen on one side, which displays the scanned images for the user. The difference between the scanning pen and the scanner is that the former is portable and can fulfill the scanning work independently without the support of a PC (i.e., it has an internal memory and a scanning program). More importantly, it may scan necessary parts of the pages instead of entire pages. Thus the user may scan the pages as required without wasting time on unnecessary parts. Though such a scanning pen overcomes the shortcomings of scanners (i.e., can't be used independently, difficult to carry, can's scan parts of pages), the images scanned can only be viewed through the display screen, the visible scope of which is too small to display all images scanned, resulting in inconvenience.

Therefore, to display the entire scanned image, the scanning pen has to be connected to a PC through a transmission component to display the scanned images on the computer screen. However, the images displayed on the computer screen can only be viewed by the user sitting in front of it instead of shared by all audiences. If the images can be projected to an ambient plane, they can be view by all audiences. However, current projection devices only deliver simple projection imaging function and require a PC to transfer the images to them. Furthermore, they are not portable, which brings inconvenience to the user. Therefore, it is urgent task to provide a device that comprises a portable main body but delivers image scanning and other data processing functions without the help of a PC, moreover, the main body may has a project device, which can project the images and data to any plane facilitate viewing without assistance of any visible display device.

### SUMMARY OF THE INVENTION

To attain above purposes, the inventor provides a data processing device with projection imaging function through diligent study and tests.

The main purpose of the invention is to provide a data processing device with projection imaging function, wherein said data processing device is designed as portable and can project the data processed to any spatial plane through projection imaging to facilitate the audiences to view the data.

Another purpose of the invention is to provide a data processing device with projection imaging function, wherein said data processing device can fulfill data scan and/or recognition and/or translation work independently without the support of a PC, in order to attain the goal of “obtain necessary information at any time any place”.

To attain above and other purposes and efficacies, the invention provide a data processing device with projection imaging function, wherein said data processing device comprises a main body with an optical scanning mechanism that can scan any form of pages as well as an internal operation module for the optical scanning mechanism. The data processing device is featured with: the main body has a projection mechanism with a projection lens; cooperating with the operation module, the projection mechanism can directly project the data scanned to any spatial plane in light projection way.

In addition, the invention provides a data processing device with projection imaging function, wherein said data processing device has the following data processing modes: scan mode and/or recognition mode and/or translation mode; in the scan mode, the page data is converted into digital images; in the recognition mode, the digital images are converted to editable data; in the translation mode, the editable data is translated to another language. In that way, with the projection imaging function, data in different modes may be projected to any spatial plane.

To understand above and other purposes, features, and benefits of the invention better, the invention is described in the following embodiments, with reference to the attached drawings.

### DETAIL DESCRIPTION OF THE EMBODIMENTS

Please see FIG. 1 and FIG. 2, a preferred embodiment of the data processing device with projection imaging function described in the present invention, wherein said data processing device comprises a main body 1 with an optical scanning mechanism 10 and a projection mechanism 12 on it and several operation modules corresponding to said mechanisms 10 and 12 in it. Said operation modules include a data processing module 16, a power supply module 18, and a MMI module 14, all of them will be described later.

The optical scanning mechanism 10 is located at one end of the main body 1 and comprises at least an optical scanning lens 101 and a photoelectric conversion element not shown, wherein the optical scanning lens 101 contacts directly with the page data 20 e.g., newspapers, magazines, articles, or books to scan the data in them. The data scanned exists as photons and then is converted into electric data that can be received and processed by the data processing module 16 in the main body 1 with the photoelectric conversion element. The projection mechanism 12 is located at the other end or one side of the main body and comprises a projection lens 121 and a photoelectric inversion element not shown, wherein said photoelectric inversion element is used to receive the digital data transferred from the data processing module and invert the digital data into photons; the projection lens 121 is a laser one or other form, and it receives the data in photon form from the photoelectric inversion element and projects the data to any display space 22. To avoid any distortion of the fonts displayed, the display space 22 is preferable a planar space (e.g., a wall). However, it is noted that the display space is not limited to any planar space; instead, any space is permitted only if it can accommodate all the data projected by the projection mechanism 12. In addition, the focus of the projection mechanism 12 on the main body 1 may be adjusted according to the distance from it to the display space 22 so that the font size of the data displayed on the display space may be adjusted as required.

Hereunder we will describe the operation of said optical scanning module 10 and said projection mechanism 12 with reference to the operation modules data processing module 16, power supply module 18, and MMI module 14 in the main body 1.

Please see FIG. 1, wherein the data processing module 10 is wired to the optical scanning mechanism 10 and the projection mechanism 12. When it receives electronic signals from the optical scanning mechanism 10, it converts the electronic signals into different forms of digital data according to the mode scan mode, recognition mode, translation mode selected by the user. In scan mode, the data processing module 16 converts the page data 20 into digital images; in recognition mode, the data processing module 16 converts the digital images to editable data i.e., abstracts texts or pictures from images converted in said scan mode and makes the editable; in translation mode, the data processing module 16 translates the editable data recognized into another language with its language translation function (e.g., from Chinese to English or Japanese, or from Traditional Chinese to Simplified Chinese).

The main body 1 has at least an internal memory (not shown), which is used to store above digital data (e.g., scanned data, recognized data, and translated data) converted from the data processing module 16. There is a status display unit on the casing of the main body 1. Said status display unit is controlled by the data processing module 16 to indicate whether the digital data has been converted by the data processing module 16, wherein said status display unit may be an LED indicator 161 (as shown in FIG. 2) or a small screen (not shown). A LED indicator indicates the status with bright/dark pattern, while a small screen indicates the status with status word. It is noted that the small screen in the present invention is used to indicate the status with a fewer of words instead of displaying the scanned data with a large amount of words.

Several function buttons (including a mode selection button 141 and a projection button 142) for the operation of the MMI module 14 are devises on the casing of the main body 1. The mode selection button 141 is used to enable the user to select the processing mode for the digital data; the projection button 142 is used to launch the projection mechanism 12 and control the data display speed during projection.

In addition, to support the normal operation of said data processing module 16, MMI module 14, optical scanning mechanism 10, and projection mechanism 12, a power supply module 18 is devised in the main body 1 and is used to deliver power to those operation modules and corresponding mechanism and parts.

Please see FIG. 1˜3D, wherein the data processing device with projection imaging function described in the present invention operates according to the user's translation request. FIG. 3B˜3D show the data processing device is performing scanning, data translation, and projection of the translated data, respectively.

First, the user makes the optical scanning lens 101 on the main body 1 contacts with the paragraphs (e.g., “This is a book”) to be translated on the page data 20. Next, the user switch the mode selection button 141 to translation mode (step 300), the MMI module 14 receives the translation instruction issued by the user, informs the data processing module 16 of the translation mode, and control the optical scanning mechanism 10 to scan (step 302). The optical scanning mechanism 10 converts the content of the paragraphs scanned by the scanning lens 101 into electronic signals and transfers the signals to the data processing module 16 (step 304). Thus the scan operation shown in FIG. 3B is finished.

In FIG. 3C, data processing module 16 receives the electronic signals and converts and rearranges them to digital image identical to the page data, and then recognizes the texts in the digital image and converts them into editable texts; next, it translates the recognized texts into another language (e.g., “ [symbol] ”) specified by the user (step 306); when the texts are translated, the data processing module 16 controls the status display unit (e.g., indicator 161 in FIG. 3C) to flash or change in any other form to indicate that the current data is translated (step 308).

In FIG. 3D, when the user receives the indication of translation completion, he/she may press down the projection button 142 (step 310); the MMI module 14 receives the instruction and informs the data processing module 16 to transfer the translated data to the projection mechanism 12 (step 312), which receives the data and projects the translation result (i.e., “ [symbol] ” to an appropriate planar space (step 314).

In above embodiment, an expansion slot 162 and a transmission interface (not shown) may be devised at an appropriate position on the main body 1; wherein the expansion slot 162 may accommodate a memory card (e.g., SD card, MS card, MMC card, SM card, or XD card), which may store digital data converted by the data processing module 16 to complement the embedded memory. The transmission interface (not shown) may serve as the connection interface between the device and a PC system to enable data exchange between them or data upload to the PC system. Said transmission interface may be a USB, IEEE1394, or any other transmission interface and may be designed in plug form, cable form, or socket form.

In conclusion, the present invention is disclosed as above with preferred embodiments. However, it is noted that above embodiments shall not constitute any limitation to the invention. Any person familiar with the technologies may carry out modifications or embellishments to the embodiments without deviating from the concept and scope of the invention. Therefore, the scope of the invention is solely defined with the attached claims. Any embodiment implemented with equivalent modifications or embellishments to the invention shall fall in the scope of the invention.

### BRIEF DESCRIPTION OF THE DRAWINGS

FIG. 1 is a box diagram of the circuit of a preferred embodiment of the data processing device with projection imaging function described in the present invention.

FIG. 2 is the structural diagram of a preferred embodiment of the data processing device with projection imaging function described in the present invention.

FIG. 3A is a flow diagram of actions in translation mode according to FIG. 1 and FIG. 2.

FIG. 3B˜3D is a sketch map of the operation in translation mode described in FIG. 3A.

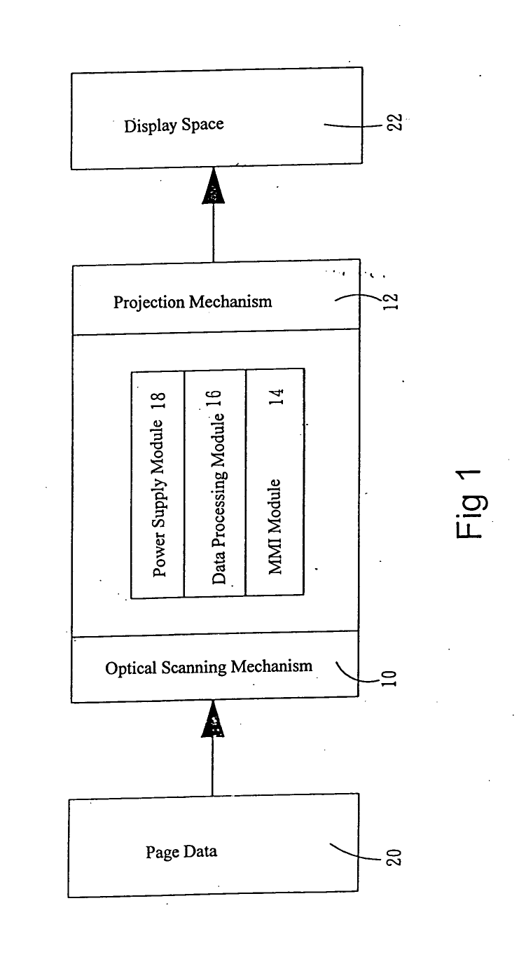

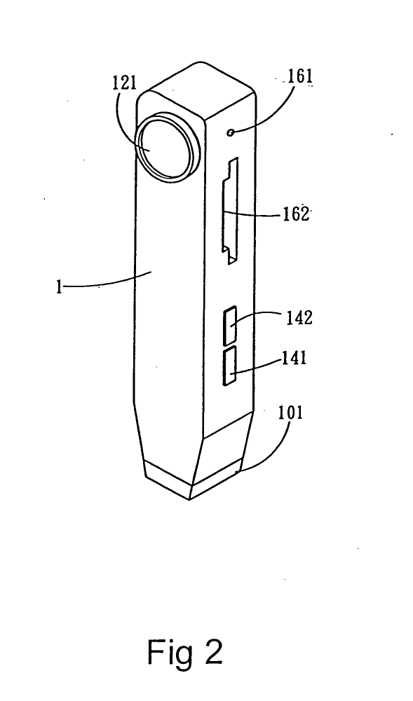

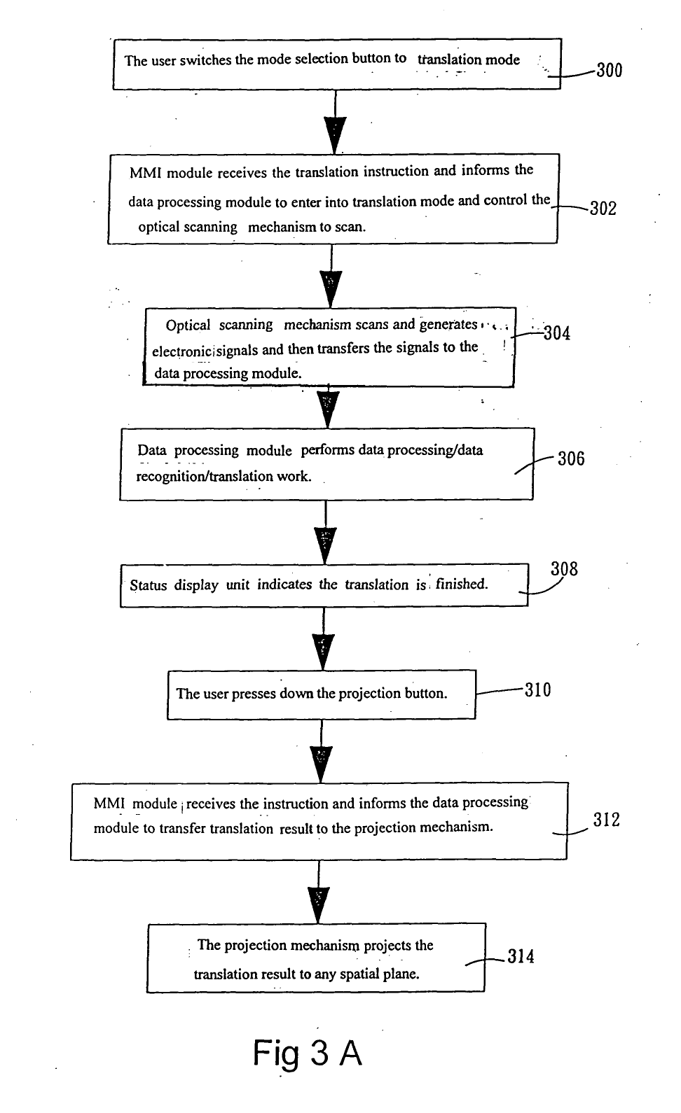

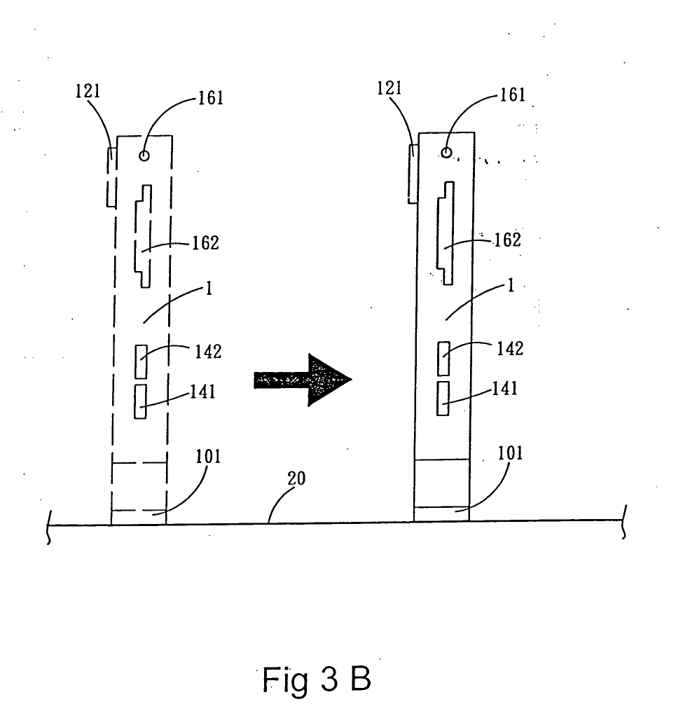

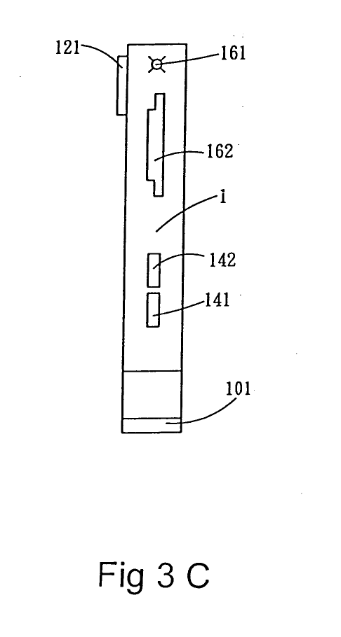

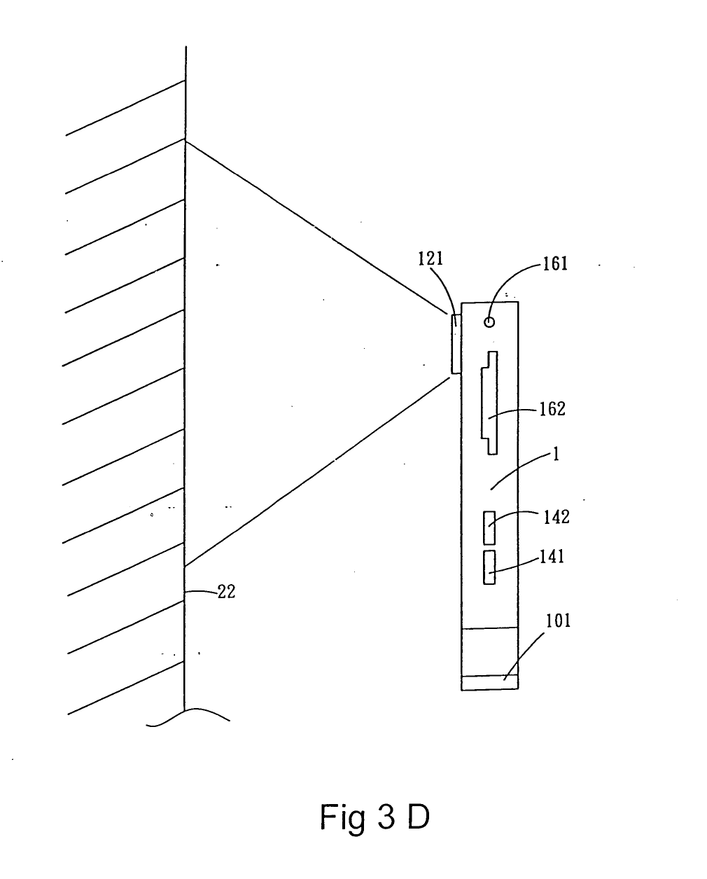

Step 300·314 shows the operation steps of a preferred embodiment of the invention.

1: Main Body

10: Optical Scanning Mechanism

101: Optical Scanning Lens

12: Projection Mechanism

121: Projection Lens

14: MMI Module

141: Mode Selection Button

142: Projection Button

16: Data Processing Module

161: Indicator

162: Expansion Slot

18: Power Supply Module

20: Page Data

22: Display Space

What is claimed is:

1. A data processing device with projection imaging function, mainly comprising a main body with an optical scanning mechanism that may scan any form of page data and a plurality of internal operation modules that may convert said page data scanned into digital data as required; wherein said data processing device is featured with: a projection mechanism corresponding to said operation modules is devised at an appropriate position on the main body to project the processed data to any planar space.

2. The data processing device with projection imaging function as in claim 1, wherein said optical scanning mechanism at least has an optical scanning lens that may contacts with the page data and a photoelectric conversion element.

3. The data processing device with projection imaging function as in claim 1, wherein said projection mechanism is a laser one.

4. The data processing device with projection imaging function as in claim 1 or 3, wherein said projection mechanism at least has a projection lens and a photoelectric inversion element.

5. The data processing device with projection imaging function as in claim 1, wherein said operation modules includes a data processing module that may convert the images scanned into digital data as required according to the user's selection.

6. The data processing device with projection imaging function as in claim 5, wherein said data processing module has a scan mode, in which the converted digital data exists as images.

7. The data processing device with projection imaging function as in claim 5, wherein said data processing module has a recognition mode, in which the converted digital data exists as editable texts.

8. The data processing device with projection imaging function as in claim 5, wherein said data processing module has a translation mode, in which the converted digital data exists in a language different to original page data.

9. The data processing device with projection imaging function as in claim 6, 7, or 8, wherein a memory is embedded in the main body to store the converted digital data.

10. The data processing device with projection imaging function as in claim 6, 7, or 8, wherein an expansion slot is devised on the main body to accommodate a memory card, which may store the converted digital data.

11. The data processing device with projection imaging function as in claim 6, 7, or 8, wherein a transmission interface that may be connected to a PC is devised on the main body to exchange data with the PC.

12. The data processing device with projection imaging function as in claim 11, wherein said transmission interface may be a USB, IEEE1394, or any other transmission interface.

13. The data processing device with projection imaging function as in claim 6, 7, or 8, wherein a status display unit is devised on the main body to indicate whether the digital data has been converted by the data processing module.

14. The data processing device with projection imaging function as in claim 13, wherein said status display unit comprises a LED indicator or small screen.

15. The data processing device with projection imaging function as in claim 6, 7, or 8, wherein a mode selection button, and projection button, and other function buttons are devised on the main body.

16. The data processing device with projection imaging function as in claim 15, wherein said operation modules include a MMI module, which operates in correspondence with the operation of the mode selection button, the projection button, and other function buttons.

17. The data processing device with projection imaging function as in claim 1, wherein said operation modules includes a power supply module, which delivers power to said operation modules and corresponding mechanisms.
